(19) United States
(12) Patent Application Publication
(10) Pub. No.: US 2008/0073175 A1
(43) Pub. Date: Mar. 27, 2008

(54) POWER TRANSMISSION APPARATUS FOR A COMPRESSOR

(75) Inventors: Suk-Jae CHUNG, Daejeon (KR); Hun-Sang Lee, Daejeon (KR)

Correspondence Address: RABIN & Berdo, PC, 1101 14TH STREET, NW, SUITE 500, WASHINGTON, DC, 20005, US

(73) Assignee: HALLA CLIMATE CONTROL CORP., Daejeon (KR)

(21) Appl. No.: 11/860,411

(22) Filed: Sep. 24, 2007

(30) Foreign Application Priority Data
Sep. 26, 2006 (KR) 10-2006-0093251

(51) Int. Cl. F16D 41/07

(52) U.S. Cl. 192/41 A

(57) ABSTRACT

In a power transmission apparatus for a compressor according to the present invention, a package of the compressor is reduced in size by shortening the longitudinal length of a one-way bearing while a predetermined level of transmission torque is sustained by optimizing the locations of the one-way bearing and a ball bearing module. Therefore, the mountability thereof can be improved. Also, the one-way bearing is disposed at an outer side from the ball bearing module in a radial direction so as to increase the number of rollers constituting the one-way bearing. Therefore, the transmission torque can be kept identically to that of the related art although the length of the one-way bearing is shortened.

### CROSS-REFERENCE TO RELATED PATENT APPLICATION

This application claims the benefit of Korean Patent Application No. 10-2006-0093251, filed on Sep. 26, 2006, in the Korean Intellectual Property Office, the disclosure of which is incorporated herein in its entirety by reference.

### FIELD OF THE INVENTION

The present invention relates to a power transmission apparatus for a compressor; and, more particularly, to a power transmission apparatus for a compressor, which keeps a predetermined level of transmission torque by optimizing the locations of a one-way bearing and a ball bearing module and reduces a package of the compressor in size by shortening the longitudinal length of the one-way bearing, thereby improving the mountability thereof, and which sustains the transmission torque although the length of the one-way bearing is shortened by installing the one-way bearing at an outer side from the ball bearing module in a radial direction so as to increase the number of rollers constituting the one-way bearing.

### DESCRIPTION OF RELATED ARTS

Generally, an air conditioning system for a vehicle serves to keep the interior temperature of the vehicle lower than the exterior temperature through the circulation of refrigerant, for example, compressing, condensing, expanding, and evaporating the refrigerant. Accordingly, the air conditioning system essentially includes a compressor, a condenser, an expansion valve, and an evaporator.

The compressor is a machine that compresses the refrigerant and discharges the compressed refrigerant using the power of an engine. The cooling capacity of an air conditioning system is generally decided by the discharging amount of refrigerant of the compressor. In order to control the discharging amount of the refrigerant by changing the driving force of the compressor, a power transmission apparatus connecting the compressor and the engine includes a clutch. The clutch temporarily suspends the power transmitted from the engine.

Recently, a hybrid vehicle has been developed to use both of an engine and a motor as a drive source of a vehicle due to the various controls of exhaust gas and high oil price. Such a hybrid vehicle includes a hybrid compressor as a compressor of the air conditioning system. The hybrid compressor is independently driven by one of an engine and a motor. Since a conventional compressor cannot be driven when a vehicle uses a motor as a drive source, the hybrid vehicle cannot use the conventional compressor.

The hybrid compressor includes an engine driving part for transmitting the driving force of a engine to the compressor, and a motor driving part for transmitting the driving force of a motor to the compressor. A one-way bearing type clutch is disposed to transmit the rotation force from the engine driving part or the motor driving part in one direction and cut off in the other direction.

FIG. 1 is a cross-sectional view of a power transmission apparatus for a compressor according to the first related art, and FIG. 2 is a cross-sectional view of a one-way clutch according to the second related art.

The power transmission apparatus for a compressor according to the first related art was disclosed in US 2003/0098216. As shown in FIG. 1, in a one-way clutch assembly 14, a first, second and third rings 15, 16, 17 are coaxially aligned in the radial direction of a rotary shaft

The second and third rings 16, 17 each are operatively connected to the first ring 15 that integrally rotates with the rotary shaft 11 to transmit the power.

In comparison to a structure that includes two one-way clutches each having two rings and being respectively placed in power transmission paths between the rotary shaft 11 and a pulley 12 and between the rotary shaft 11 and a electric motor 13, the number of rings reduces. In other words, the number of the independent components reduces in the compressor 10. As a result, the size of the compressor 10 will be reduced.

The power transmission apparatus for a compressor according to the second related art was disclosed in U.S. Pat. No. 7,093,703. As shown in FIG. 2, the inner diameter surface of an inner race 21 is fitted to a shaft S and the outer diameter surface of an outer race 22 is fitted to a housing H. Usually, these fits are realized by an interference fit so as to disable a relative rotation with respect to the fitting counterparts.

Since steps 23 and 24 are formed, the radial thickness of the portions of inner race 21 and outer race 22 where one-way clutch raceway surfaces 21b and 22b are formed are reduced. As a result of this tinning, there arises the possibility that the inner race 21 or the outer race 22 follows the shape of the fitting surface of the corresponding counterpart. In the case where the shape accuracy is poor, there is the possibility that also the shape accuracy the one-way clutch raceway surface 21b or 22b is impaired.

To comply with this, in the inner race 21 or the outer race 22 which is on the side of one of the counterparts or the shaft S and the housing H that has higher shape accuracy of the fitting surface, the height of the step is increased, whereby the shape accuracy is prevented from exerting an influence. Usually, the shape accuracy of the fitting surface of the shaft S is higher. In this case, therefore, the step 23 of the inner race 21 is set to be larger than the step 24 of the outer race 22, whereby the portion of the inner race 21 where the one-way clutch raceway surface 21b is made thinner, and that of the outer race 22 where the one-way clutch raceway surface 22b is made thicker. According to the configuration, the shape accuracies of both one-way clutch raceway surfaces 21b and 22b can be kept excellent while ensuring a desired J space, where the J space denotes a dimension between the inner race and the outer race.

That is, according to the second related art, in each of the inner race and the outer race, the step is formed between the shoulder of the rolling bearing raceway surface and the one-way clutch raceway surface, whereby the J space formed between the one-way clutch raceway surfaces of the inner and outer races can be made wider than the dimension formed by the shoulder of the rolling bearing raceway surface. According to the configuration, larger sprags can be used, and the performance including the transmission torque can be improved without causing the whole size to be increased as compared with a conventional one. In one of the inner and outer races which is on the side of a counterpart having a higher shape accuracy of the fitting surface, the step of the race is made larger, whereby degradation of the shape of the one-way clutch raceway surface which is caused by following to the counterpart due to the thickness reduction can be prevented from occurring.

In short, since a motor is additionally installed for the hybrid compressor that receives the driving power from an engine and a motor, the package of the hybrid compressor becomes extended in a longitudinal direction compared to a conventional compressor, thereby badly influencing the mountability of the hybrid compressor. In order to increase the mountability, it is better to shorten the package in the longitudinal direction. It needs to shorten the longitudinal length of a driving shaft connection member in order to shorten the package in the longitudinal direction.

However, the transmission torque of a one-way bearing becomes reduced if the longitudinal length of the driving shaft connection member is shortened. In order to sustain transmission torque, the driving shaft connection member must increase in a size. Accordingly, the pulley becomes increased in a size. The power transmission apparatus according to the related art also provided the solutions for the above described problems. That is, the power transmission apparatus according to the first related art reduces the number of parts by forming one-way clutch with two one-way clutches, and the power transmission apparatus according to the second related art improves the transmission torque without the entire size thereof increased by forming the step between the rolling bearing raceway surface and the one-way clutch raceway surface. However, the power transmission apparatus according to the first and second related arts cannot reduce the size of the package of the compressors while a predetermined level of a transmission torque is kept.

### SUMMARY OF THE INVENTION

It is, therefore, an object of the present invention to provide a power transmission apparatus for a compressor, which keeps a predetermined level of transmission torque by optimizing the locations of a one-way bearing and a ball bearing module and reduces a package of the compressor in size by shortening the longitudinal length of the one-way bearing, thereby improving the mountability thereof.

It is another object of the present invention to provide a power transmission apparatus for a compressor, which sustains the transmission torque although the length of a one-way bearing is shortened by installing the one-way bearing at an outer side from a ball bearing module in a radial direction so as to increase the number of rollers constituting the one-way bearing.

In accordance with an aspect of the present invention, there is provided a power transmission apparatus for a compressor including a pulley, a hub, and a power transmission member. The pulley rotates by a driving force transmitted from an engine. The hub is connected to a driving shaft of the compressor which is driven by the engine or a motor and transmits the rotation force of the pulley to the compressor. The power transmission member is disposed between the pulley and the hub for transmitting or cutting off the driving power to the compressor selectively. The driving shaft connection member connects the power transmission member and the driving shaft. The driving shaft connection member includes an inner race having a one-way bearing installing portion for disposing a one-way bearing at an outer side thereof and a ball bearing module installing portion for disposing a ball bearing module at an inner side thereof, and an outer race formed to surround outsides of the one-way bearing and the ball bearing module. The one-way bearing is positioned at an outer side from the ball bearing module installing portion in a radial direction of the driving shaft.

The power transmission member may include an inner ring having a screwing portion formed at an inner circumference side, an outer ring having an inserting portion inserted into the pulley, and a break member for connecting the inner ring and the outer ring and for disconnecting the inner ring and the outer ring by being broken□down when a torque higher than a predetermined threshold is applied to a compressor.

The outer race may include a screwing portion formed at an outer circumference side, which is screw□connected to the inner ring of the power transmission member.

The screwing portion may be formed at an outer circumference side of the outer race corresponding to the ball bearing module installing portion.

### BRIEF DESCRIPTION OF THE DRAWINGS

The above and other features and advantages of the present invention will become more apparent by describing in detail exemplary embodiments thereof with reference to the attached drawings in which:

FIG. 1 is a cross-sectional view of a power transmission apparatus for a compressor according to the first related art;

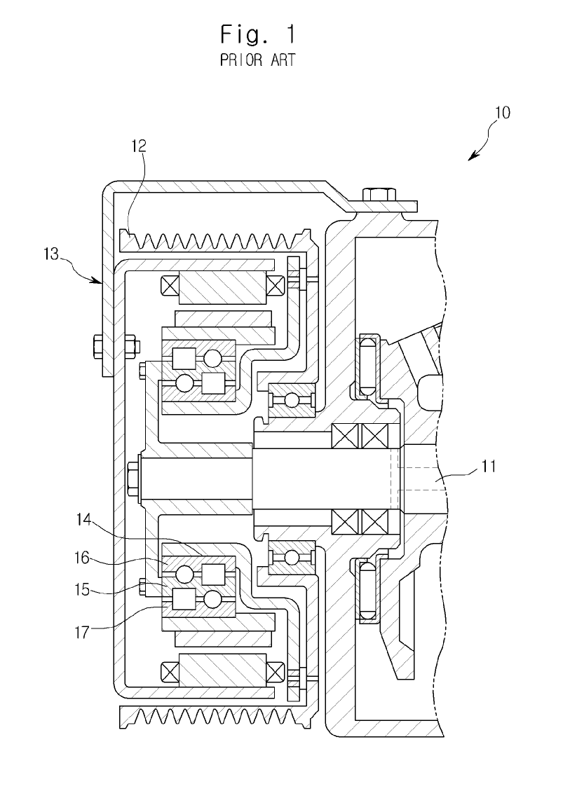

FIG. 2 is a cross-sectional view of a one-way clutch according to the second related art;

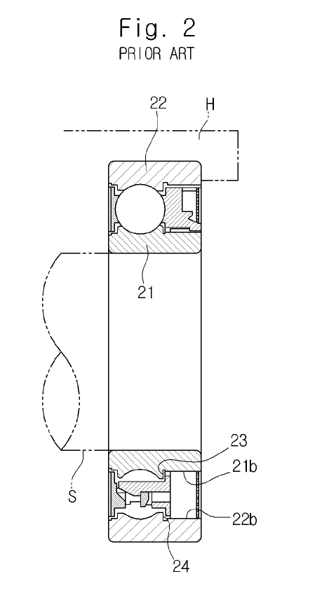

FIG. 3 is a cross-sectional view of a power transmission apparatus for a compressor according to an embodiment of the present invention; and

FIG. 4 is a cross-sectional perspective view of a power transmission apparatus for a compressor according to an embodiment of the present invention.

### DETAILED DESCRIPTION OF THE INVENTION

Hereinafter, a power transmission apparatus for a compressor will be described in more detail with reference to the accompanying drawings.

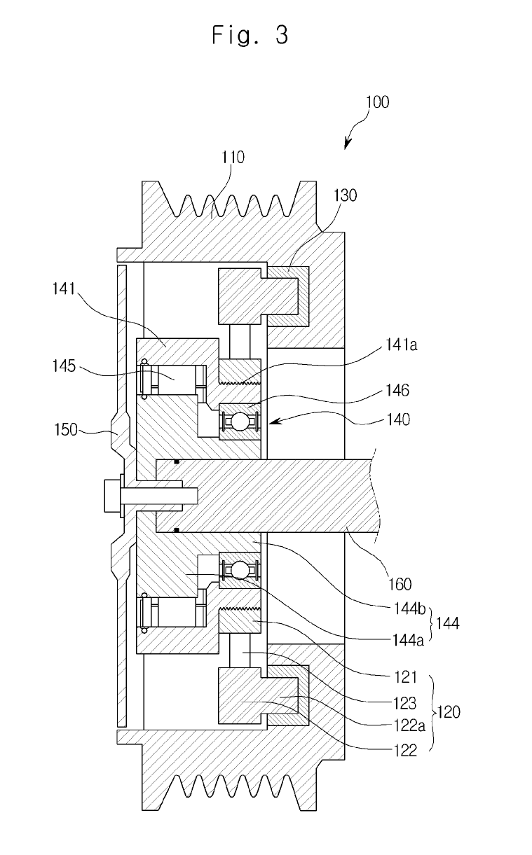

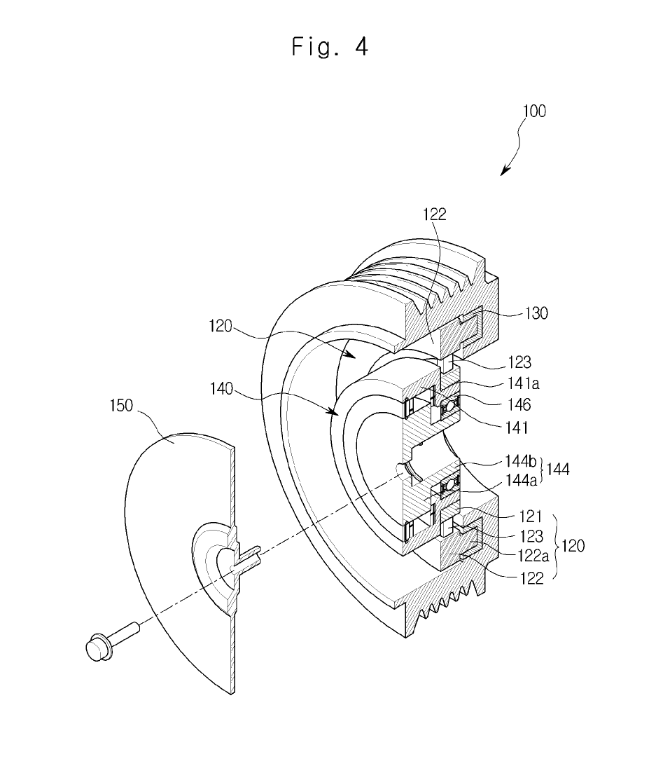

FIG. 3 is a cross-sectional view of a power transmission apparatus for a compressor according to an embodiment of the present invention, and FIG. 4 is a cross□sectional perspective view of a power transmission apparatus for a compressor according to an embodiment of the present invention.

The power transmission apparatus for a compressor 100 includes a pulley 110 rotating by a driving force transmitted from an engine, a hub 150 for transmitting the rotating force of the pulley to the compressor, a power transmission member 120 disposed between the pulley 100 and the hub 150 for transmitting or cutting off the driving power to the compressor selectively, and a driving shaft connection member 140 for connecting the power transmission member 120 and the driving shaft 160. Since the pulley 110, the hub 150, the power transmission member 120, and the driving shaft connection member 140 are identical to those of power transmission apparatus according to the related art, the detailed descriptions thereof are omitted.

Referring to FIGS. 3 and 4, the driving shaft connection member 140 includes an inner race 144, a one-way bearing 145, a ball bearing module 146, and an outer race 141.

The inner race 144 includes a one-way bearing installing portion 144a disposed at the outside of the inner race to install the one-way bearing 145, and a ball bearing module installing portion 144b disposed at the inside thereof for installing the ball bearing module 146.

Unlike the power transmission apparatus according to the related art, the power transmission apparatus according to the present embodiment can increase in size in a radial direction without the influencing of the pitch center distance (PCD) of the pulley 100 although the locations of the one-way bearing 145 and the ball bearing module 146 change. In addition, the longitudinal length of the one-way bearing 145 can be reduced while the predetermined level of transmission torque is kept, thereby making possible to reduce the package of the compressor.

The outer race 141 is formed to surround the outsides of the one-way bearing 145 and the ball bearing module 146. The outer race 141 having a screwing portion 141a formed at the outer circumference side to be screw□connected to the inner ring 121 of the power transmission member 120.

In order to dispose the one-way bearing 145 at a further outer side from the ball bearing module 146 in a radial direction, the one-way bearing installing portion 144a is disposed at an outer side from the ball bearing module installing portion 144b in a radial direction. In this case, the transmission torque can be identically kept although the length of the one-way bearing is shortened by increasing the number of rollers constituting the one-way bearing 145 compared to the conventional power transmission apparatus.

The power transmission member 120 includes an inner ring 121 having a screwing portion at an inner circumference side thereof, an outer ring 122 having an inserting portion 122a inserted into the pulley 110, and a break member 123 for connecting the inner ring 121 and the outer ring 122 and for disconnecting the inner ring 121 and the outer ring 122 by being broken down if a torque higher than a predetermined threshold is applied to the compressor.

Hereinafter, the connections and the operations of the power transmission apparatus according to an embodiment of the present invention will be described with reference to FIGS. 3 and 4.

At first, the inserting portion 122a of the outer ring 122 is inserted among a plurality of dampers 130 and fixed at the inner front side of the pulley 110. The screwing portion 141a formed at the outside of the outer race 141 of the driving shaft connection member 140 is fixed at the inner circumference side of the inner ring 121.

The one-way bearing 145 is disposed at the outside of the one-way bearing installing portion 144a of the inner race 144, and the ball bearing module 146 is disposed at the outside of the ball bearing module installing portion 144b of the inner race 144.

The driving shaft 160 of the compressor is inserted to and fixed at the inner circumference side of the inner race 144.

The power transmission apparatus for a compressor according to the present embodiment transmits the power as follows. At first, a rotation force is transmitted from an engine to the pulley 110, and the pulley 110 transmits the rotation force to the damper 130. Then, the transmitted rotation force rotates the power transmission member 120 connected to the damper 130, and the rotation force is transmitted to the driving shaft connection member 140 connected to the center of the power transmission member 120. Then, the driving shaft 160 connected to the inner race 144 of the driving shaft connection member 140 rotates, thereby driving the compressor.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A power transmission apparatus for a compressor comprising:
a pulley rotating by a driving force transmitted from an engine;
a hub connected to a driving shaft of the compressor which is driven by the engine or a motor and transmitting the rotation force of the pulley to the compressor;
a power transmission member disposed between the pulley and the hub for transmitting or cutting off the driving power to the compressor selectively; and
a driving shaft connection member for connecting the power transmission member and the driving shaft,
wherein the driving shaft connection member includes:
an inner race having a one-way bearing installing portion for disposing a one-way bearing at an outer side thereof and a ball bearing module installing portion for disposing a ball bearing module at an inner side thereof; and
an outer race formed to surround outsides of the one-way bearing and the ball bearing module, and
wherein the one-way bearing is positioned at an outer side from the ball bearing module installing portion in a radial direction of the driving shaft.

2. The power transmission apparatus for a compressor of claim 1, wherein the power transmission member includes an inner ring having a screwing portion formed at an inner circumference side, an outer ring having an inserting portion inserted into the pulley, and a break member for connecting the inner ring and the outer ring and for disconnecting the inner ring and the outer ring by being broken□down when a torque higher than a predetermined threshold is applied to the compressor.

3. The power transmission apparatus for a compressor of claim 2, wherein the outer race includes a screwing portion formed at an outer circumference side, which is screw-connected to the inner ring of the power transmission member.

4. The power transmission apparatus for a compressor of claim 3, wherein the screwing portion is formed at an outer circumference side of the outer race corresponding to the ball bearing module installing portion.
